(19) United States
(12) Patent Application Publication
(10) Pub. No.: US 2026/0269476 A1
(43) Pub. Date: Sep. 10, 2026

(54) ANTENNA

(71) Applicant: NXP B.V., Eindhoven (NL)

(72) Inventors: Shambulingappa Vadeyanapur, Hirekerur (IN); Levent Gurel, Menlo Park, CA (US)

(21) Appl. No.: 19/560,834

(22) Filed: Mar. 9, 2026

(30) Foreign Application Priority Data
Mar. 10, 2025 (IN) 202541021410

(51) Int. Cl. H01Q 9/04; H01Q 1/42; H01Q 13/18

(52) U.S. Cl. CPC H01Q 9/0414; H01Q 1/422; H01Q 13/18

(57) ABSTRACT

An integrated patch antenna with a plurality of layers, comprising: a reference plane, positioned in a first layer, wherein the reference plane is configured to provide a connection to a reference voltage; a driving patch, positioned in a second layer, wherein the first layer is separated from the second layer by a plurality of layers, such that: the driving patch is positioned above the reference plane, a volume between the reference plane and the driving patch defines a first resonant cavity, and the integrated patch antenna comprises a plurality of layers within the first resonant cavity. The integrated patch antenna also comprises a feed line configured to connect the driving patch to a transmitter or receiver, comprising: a first conductive via positioned in the first resonant cavity, galvanically connected to the driving patch; and a first conductive trace, galvanically connected to the first conductive via.

This application claims the priority under 35 U.S.C. § 119 of Indian Patent application no. 202541021410 filed on 10 Mar. 2025, the contents of which are incorporated by reference herein.

### FIELD

The present disclosure relates to an integrated patch antenna. In particular to an integrated patch antenna with a plurality of layers.

### SUMMARY

According to a first aspect of the present disclosure, there is provided an integrated patch antenna with a plurality of layers, the integrated patch antenna comprising: a reference plane, positioned in a first layer, wherein the reference plane is configured to provide a connection to a reference voltage; a driving patch, positioned in a second layer, wherein the first layer is separated from the second layer by a plurality of layers, such that: the driving patch is positioned above the reference plane, a volume between the reference plane and the driving patch defines a first resonant cavity, and the integrated patch antenna comprises a plurality of layers within the first resonant cavity; a feed line configured to connect the driving patch to a transmitter or receiver, wherein the feed line comprises: a first conductive via positioned in the first resonant cavity, wherein the first conductive via is galvanically connected to the driving patch; and a first conductive trace, wherein the first conductive trace is galvanically connected to the first conductive via.

In one or more embodiments the feed line comprises: a second conductive via; and a via pad, galvanically connected to the first conductive via and the second conductive via, such that the first conductive via and the second conductive via are substantially aligned along an axis of the vias, and the second conductive via is positioned in the first resonant cavity. The second conductive via may be galvanically connected in between the first conductive via and the first conductive trace.

In one or more embodiments the feed line comprises: a second conductive via, wherein the first conductive trace is galvanically connected to the first conductive via and the second conductive via, such that the second conductive via is positioned outside the first resonant cavity.

In one or more embodiments the feed line further comprises: a transmitter or receiver terminal, positioned outside the first resonant cavity and configured to galvanically connect to a transmitter.

In one or more embodiments the integrated patch antenna comprises a parasitic patch, positioned in a third layer, such that: the parasitic patch is positioned above the driving patch; and a volume between the parasitic patch and the driving patch defines a second resonant cavity.

In one or more embodiments the patch antenna comprises a plurality of cavity vias.

In one or more embodiments each cavity via extends from a plane of the parasitic patch to the reference plane.

In one or more embodiments each cavity via is galvanically connected to the reference plane.

In one or more embodiments each cavity via is arranged adjacent to two other cavity vias, such that the plurality of cavity vias define a perimeter around an antenna cavity, wherein the antenna cavity comprises the first and second resonant cavities.

In one or more embodiments the third layer is separated from the second layer by a plurality of layers, such that the patch antenna comprises a plurality of layers within the second resonant cavity.

In one or more embodiments the patch antenna further comprises a plurality of feed lines, wherein each feed line of the plurality of feed lines is configured to galvanically connect the driving patch to a transmitter or receiver.

In one or more embodiments the transmitter or receiver is galvanically connectable to one or more feed lines.

In one or more embodiments each feed line comprises: a conductive via positioned in the first resonant cavity, wherein the first conductive via is galvanically connected to the driving patch; and a conductive trace, wherein the conductive trace is galvanically connected to the first conductive via.

According to a further aspect of the present disclosure there is provided an integrated circuit, IC, comprising: a transmitter or receiver; and any patch antenna disclosed herein; wherein the transmitter or receiver is galvanically connected to: the feed line of the patch antenna; or, if there are a plurality of feed lines, one or more feed lines of the plurality of feed lines.

According to a further aspect of the present disclosure there is provided an integrated circuit, IC, comprising any patch antenna disclosed herein.

Any of the ICs disclosed herein may be suitable for one or more of:

a Wi-Fi® network;

near-field communication; and

far-field communication.

Any of the ICs disclosed herein may be suitable for use with millimetre-wave frequencies.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example microstrip patch antenna;

FIG. 2 shows an example resonant cavity which is created by a microstrip patch antenna, such as the microstrip patch antenna of FIG. 1;

FIG. 3 shows example resonant cavities which are created by a stacked-patch antenna;

FIGS. 4a and 4b show an example integrated patch antenna according to an embodiment of the present disclosure;

FIG. 5 shows a cross section of an example integrated patch antenna, according to an embodiment of the present disclosure;

FIG. 6 shows a cross section of another example integrated patch antenna, according to an embodiment of the present disclosure;

FIG. 7 shows plots of the differential return loss and boresight realised peak gain against a range of frequencies for an example integrated antenna according to an embodiment of the present disclosure; and

FIG. 8 shows plots of the radiation pattern at a range of angles around the antenna.

### DETAILED DESCRIPTION

Antennas are often designed as resonant structures, operating at specific frequency bands, wherein they efficiently transmit or receive electromagnetic waves within the frequency bands.

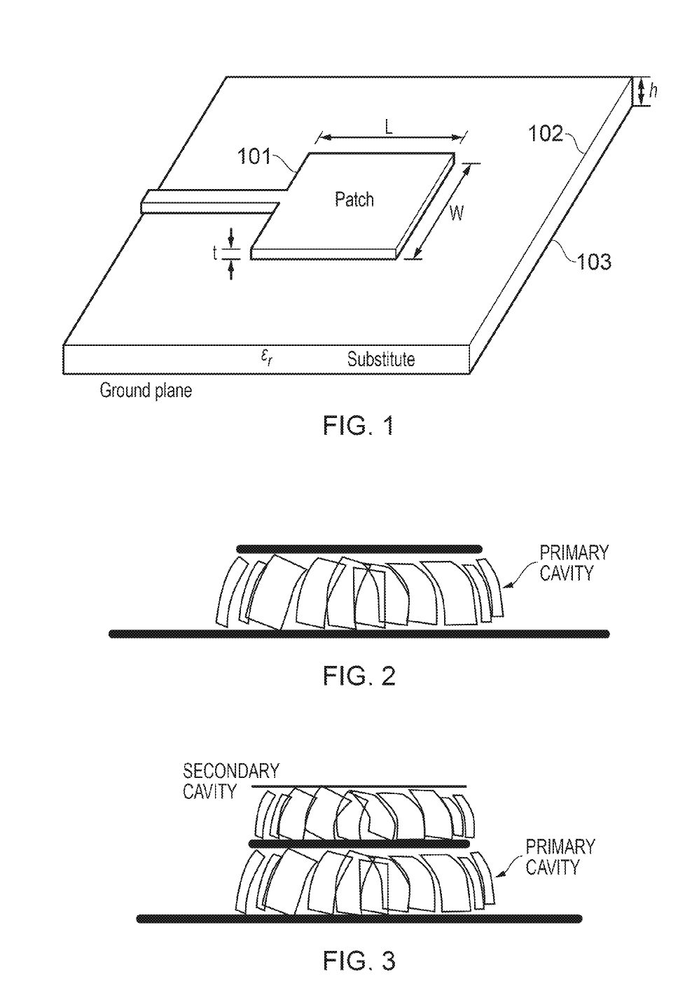

FIG. 1 shows an example microstrip patch antenna. Microstrip patch antennas are one type of resonant antenna, consisting of a metal patch 101 on a thin insulating layer 102, which is backed by a ground plane 103. This design creates a resonant cavity within the structure.

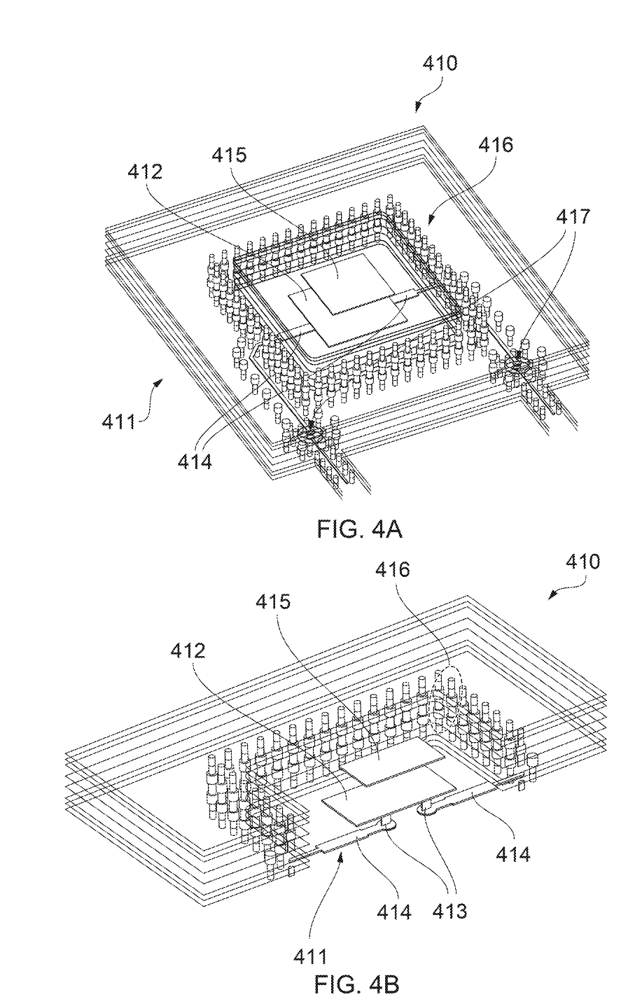

FIG. 2 shows an example resonant cavity which is created by a microstrip patch antenna, such as the microstrip patch antenna of FIG. 1. The resonant cavity (shown as “primary cavity” in the figure) behaves like a confined space where electromagnetic waves can bounce around and build up intensity at specific frequencies. This resonant behaviour allows the antenna to efficiently radiate or receive signals at those frequencies.

Compared to other common types of antennas, microstrip patch antennas are low-profile and lightweight, making them ideal for integration into portable devices, such as mobile phones and laptops. Additionally, because they can be fabricated using the same techniques as printed circuit boards, microstrip patch antennas are typically low-cost to produce.

However, for some applications, a design with only a single metal patch might not be sufficient to achieve the desired performance. To resolve this issue, stacked-patch antennas can be used when operation over a relatively wider bandwidth is required.

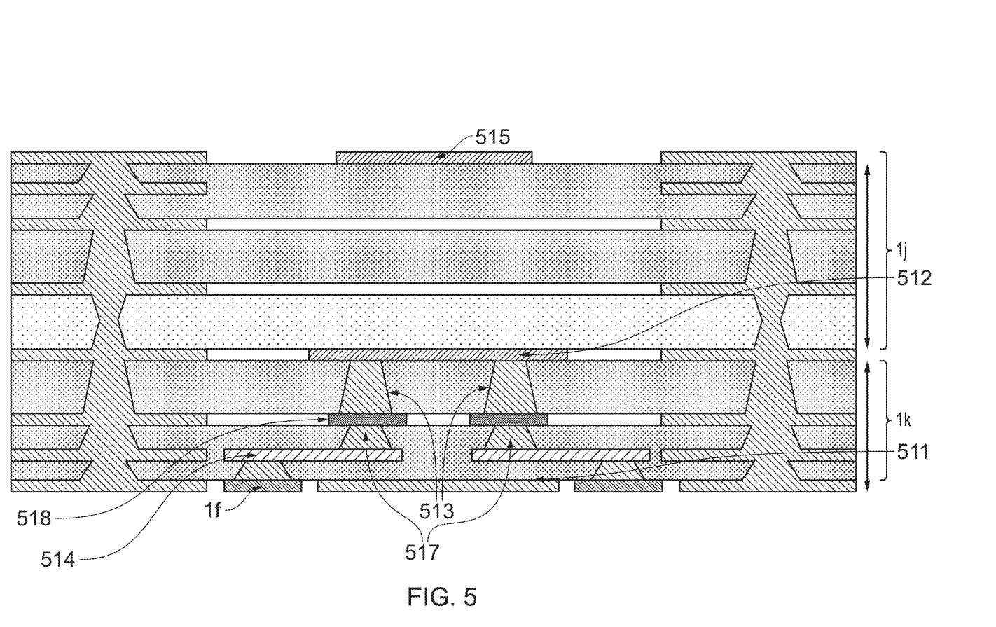

FIG. 3 shows example resonant cavities which are created by a stacked-patch antenna. Stacked-patch antennas build upon the basic design of a microstrip patch antenna by adding one or more additional metal patches, such that each metal patch is separated by one or more dielectric layers. This arrangement creates a configuration with two or more resonant structures (shown as the “primary cavity” and the “secondary cavity” in the figure).

The primary resonant structure controls the fundamental operating frequency of the antenna and is defined by a driving patch which is directly excited by one or more feed lines, as controlled by a transmitter, to initiate the resonant behaviour. In examples where the antenna is configured to receive signals, the one or more feed lines are configured to carry received signals away from the antenna, towards a receiver.

Unlike the driving patch, the one or more additional metal patches are usually not directly fed with a signal. Instead, the one or more additional metal patches are strategically placed and shaped to interact and couple with the electromagnetic waves within the primary cavity. As such, the one or more additional metal patches are referred to as parasitic patches. By carefully controlling the size, spacing, and coupling between two or more metal patches, it is possible to manipulate the overall antenna performance. This control allows for features like increased bandwidth, dual-frequency operation, or improved directivity compared to a microstrip patch antenna which only includes a single metal patch.

One of the challenges in stacked-patch antenna design, in particular, is minimizing the disruption caused by feed lines to the driving patch. Ideally, the feed lines should deliver the necessary energy to excite the driving patch without significantly altering its current distribution and resonant characteristics. The inventors have found that this can be achieved through careful positioning of the feed point (that is, the position of the galvanic connection between the feed line and the driving patch) and optimization of the feed line design to minimise the interaction between the feed line and the electromagnetic fields within the primary cavity.

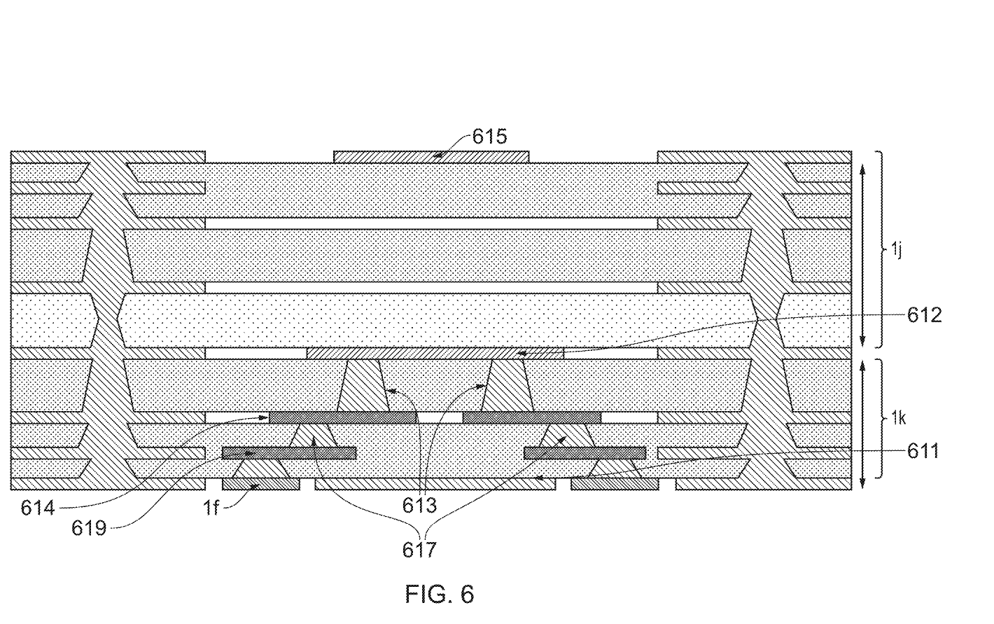

FIGS. 4a and 4b show an example integrated patch antenna 410 according to an embodiment of the present disclosure. FIG. 4a shows a perspective view of the integrated patch antenna 410, with various layers shown as transparent to assist understanding. FIG. 4b shows a cross-sectional view through the integrated patch antenna 410. The integrated patch antenna 410 in this example is provided as an integrated circuit (IC). Similar to the patch antennas discussed above, the integrated patch antenna 410 includes a reference plane 411, wherein the reference plane is configured to provide a connection to a reference voltage (such as ground). The integrated patch antenna 410 also includes a driving patch 412, wherein the driving patch 412 is positioned above the reference plane 411 such that a volume between the reference plane and the driving patch defines a first resonant cavity.

The integrated patch antenna 410 includes a plurality of layers, such that the reference plane 411 is positioned in a first layer and the driving patch 412 is positioned in a second layer. The first layer is separated from the second layer by a plurality of layers, such that the integrated patch antenna includes a plurality of layers within the first resonant cavity. That is, the first and second layers are not necessarily the uppermost or lowermost layers in the integrated patch antenna 410. Nor are the first and second layers next to each other. Purely in order to assist with this description: the layer that includes the reference plane 411 has been labelled as the first layer; and the layer that includes the driving patch 412 has been labelled as the second layer.

The integrated patch antenna 410 in this example also includes two feed lines configured to connect the driving patch to a transmitter or a receiver. each feed line comprises a first conductive via 413 and a first conductive trace 414. Each first conductive via 413 is positioned in the first resonant cavity, wherein the first conductive via 413 is galvanically connected to the driving patch 412. That is, the first conductive via 413 is contained entirely within the first resonant cavity and directly galvanically connected to the driving patch 412. Each first conductive trace 414 is galvanically connected to its corresponding first conductive via 413. The first conductive trace 414 may be contained only partially within the first resonant cavity, such that the first conductive trace is configured to transport electrical signals into or out from the first resonant cavity, to / from the driving patch 412 through the first conductive via 413.

It will be understood that, as referred to in this disclosure, a conductive via provides a galvanic connection between circuit nodes positioned across one or more layers (that is, through the thickness of the integrated patch antenna 410), and a conductive trace provides a galvanic connection between circuit nodes positioned on the same layer (that is, in a plane of the integrated patch antenna 410).

In this arrangement, the feed line is routed partially within the volume of the primary resonant cavity. This approach can achieve relatively low perturbation while offering a number of advantages, when compared to examples where the feed line is entirely external to the first resonant cavity. Such examples could include the feed line consisting of a conductive trace in the same layer as the driving patch, or the feed line comprising a conductive via which extends through the reference plane 411.

Firstly, the feed line arrangement shown in FIGS. 4a and 4b can provide precise current excitation. That is, the first conductive via 413 and the first conductive trace 414 can be positioned strategically within the first resonant cavity to deliver energy and create a desired current distribution on the driving patch 412. This level of control surpasses what can be achieved with entirely external feed lines. An optimal position of the first conductive via within the first resonant cavity is determinable by simulation, based on the details of the implementation.

Secondly, the feed line arrangement shown in FIGS. 4a and 4b can provide a reduced antenna thickness. Because the first conductive via 413 is positioned in the first resonant cavity and galvanically connected to the first conductive trace 414, which horizontally (that is, within the same layer) exits the first resonant cavity, there is no need for the first conductive via 413 to extend through the reference plane 411. Therefore, this design allows for a thinner antenna profile as there is no additional circuitry required beneath the reference plane 411. This reduced thickness is especially beneficial for applications where size and weight are critical factors.

Thirdly, the feed line arrangement shown in FIGS. 4a and 4b can require fewer dielectric layers than alternative solutions. The strategic placement of internal feed lines can potentially reduce the number of dielectric layers required in the integrated patch antenna 410. This reduced number of required dielectric layers can simplify fabrication and also lead to cost benefits.

In this embodiment, the integrated patch antenna 410 includes a parasitic patch 415, wherein the parasitic patch 415 is positioned above the driving patch 412, such that a volume between the parasitic patch 415 and the driving patch 412 defines a second resonant cavity. The advantages of this arrangement are discussed above, in relation to FIG. 3, although it will be appreciated that this feature is not essential. In this embodiment, the parasitic patch 415 is positioned in a third layer. The third layer may be separated from the second layer (that is, the layer wherein the driving patch 412 is positioned) by a plurality of layers, such that the integrated patch antenna comprises a plurality of layers within the second resonant cavity.

In this embodiment, the integrated patch antenna 410 also includes a plurality of cavity vias 416. Each cavity via 416 extends from a plane of the parasitic patch 415 to the reference plane 411, is galvanically connected to the reference plane 411, and is arranged adjacent to two other cavity vias 416. In this way, the plurality of cavity vias 416 define a perimeter around an antenna cavity, wherein the antenna cavity includes the first and second resonant cavities. Advantageously, the plurality of cavity vias 416 provides a degree of electromagnetic isolation to the first and second resonant cavities, such that a leakage of surface waves from the integrated patch antenna 410 is reduced. By reducing the surface wave leakage, the radiation performance of the antenna is improved.

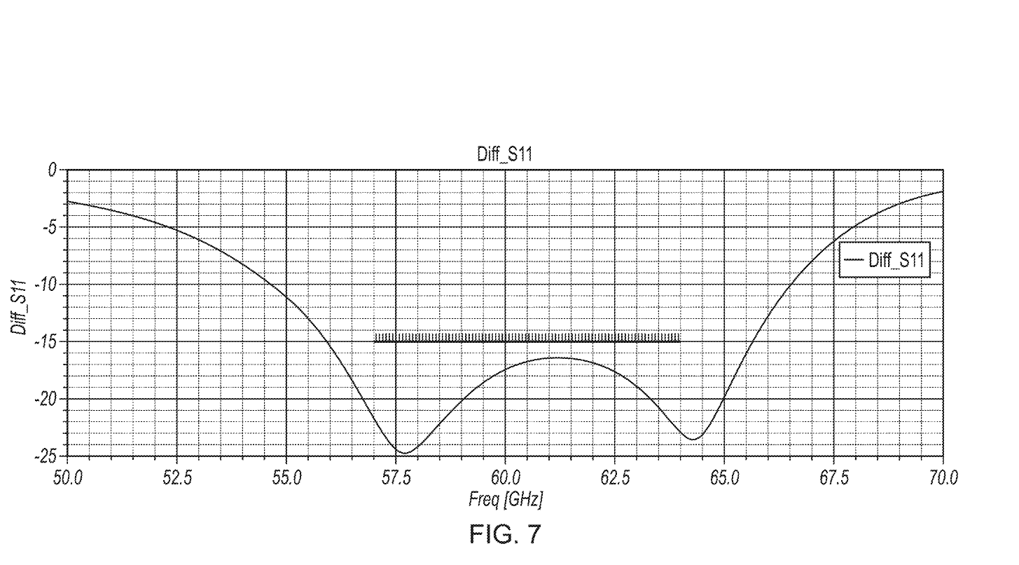

FIG. 5 shows a cross section of an example integrated patch antenna, according to an embodiment of the present disclosure. Corresponding reference numerals are used for corresponding features that are shown in other figures. Because the first layer is separated from the second layer by a plurality of layers, a plurality of conductive vias may be required to position the first conductive trace in a correct layer for connection to downstream components.

Therefore, in this embodiment, each feed line also includes a second conductive via 517 and a via pad 518, although it will be understood that each feed line may include an additional 1 to n-2 conductive vias and via pads, wherein n is the number of layers which separate the first layer and the second layer. The further additional conductive vias and via pads may be positioned and connected following the same principles as the positioning and connection of the second conductive via 517 and the via pad 518, which will now be discussed.

The via pad 518 is galvanically connected to the first conductive via 513 and the second conductive via 517, such that the first conductive via 513 and the second conductive via 517 are substantially aligned along an axis of the vias’ vertical direction (it will be appreciated that being substantially aligned also includes the first conductive via 513 and the second conductive via 517 being exactly aligned). That is, an axis which joins the central points of each face of the conductive vias 513, 517, such that the axis is normal to the layers through which the first and second conductive vias 513, 517 pass through. In this way, the second conductive via is also positioned entirely in the first resonant cavity.

During manufacturing, it may not be possible to ensure perfect layer to layer registration due to inadvertent layer shift. Therefore, it can be difficult to make the first and second conductive vias 513, 517 perfectly aligned. This can result in a change to the electromagnetic profile of the antenna, affecting resonant performance. Furthermore, the physical dimensions of the via pad 518 may further impact the resonant properties of the first resonant cavity, because the via pad 518 should be sufficient in size to facilitate galvanic connection between the two conductive vias 513, 517.

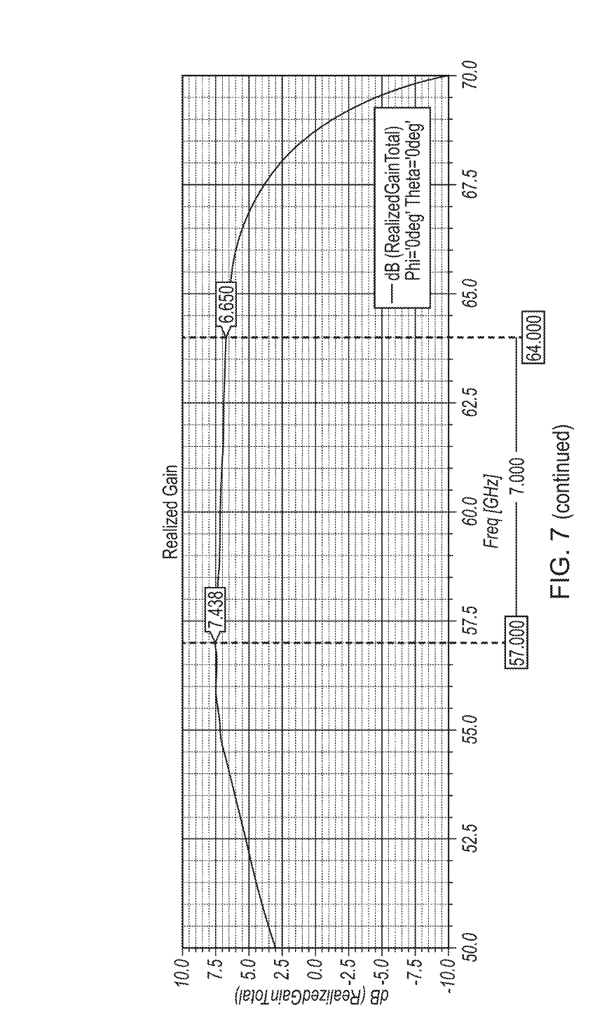

FIG. 6 shows a cross section of another example integrated patch antenna, according to an embodiment of the present disclosure. Corresponding reference numerals are used for corresponding features that are shown in other figures. In this embodiment, each feed line includes a second conductive via 617. The first conductive trace 614 is galvanically connected to the first conductive via 613 and the second conductive via 617, such that the second conductive via 617 is positioned outside of the first resonant cavity. The second conductive via 617 is equivalent to the conductive via labelled 417 in FIG. 4. Because the second conductive via 617 is positioned outside the first resonant cavity, any downstream components or routing devices (such as additional conductive vias, via pads or conductive traces) will not substantially impact the resonant characteristics of the first resonant cavity, and therefore may be positioned as desired. To demonstrate this, the embodiment shown in FIG. 6 includes an additional conductive trace 619 positioned outside the first resonant cavity.

In this way, the integrated patch antenna need not have perfect layer to layer registration in order to guarantee antenna performance. The first conductive trace 614 has a relatively small physical profile, when compared to the conductive vias 613, 617 and the via pad of FIG. 5, such that the first conductive trace 614, although positioned partially within the first resonant cavity, has a relatively small impact on the resonant characteristics of said cavity.

In some embodiments, the feed line also includes a transmitter terminal (not shown), positioned outside the first resonant cavity and configured to galvanically connect to a transmitter. The transmitter terminal may be disposed at any suitable position in the feed line, outside the first resonant cavity. This arrangement may further facilitate connection between the integrated patch antenna and a transmitter. As such, there may be provided an integrated circuit (IC) that includes a transmitter and an integrated patch antenna as described above.

The example integrated patch antennas shown in FIGS. 4a, 4b, 5 and 6 each show two feed lines, however, it will be understood that other numbers are possible and may even be preferable due to specific implementation characteristics. This can include having a single feed line, or a plurality of feed lines. In these embodiments, each feed line of the plurality of feed lines is configured to connect the driving patch to a transmitter or receiver, wherein the transmitter or receiver may be connected to one or more feed lines. As above, each feed line includes a conductive via positioned in the first resonant cavity, wherein the first conductive via is galvanically connected to the driving patch, and a first conductive trace, wherein the first conductive trace is galvanically connected to the first conductive via. It will be understood that each feed line may also include one or more of the additional features that are described above.

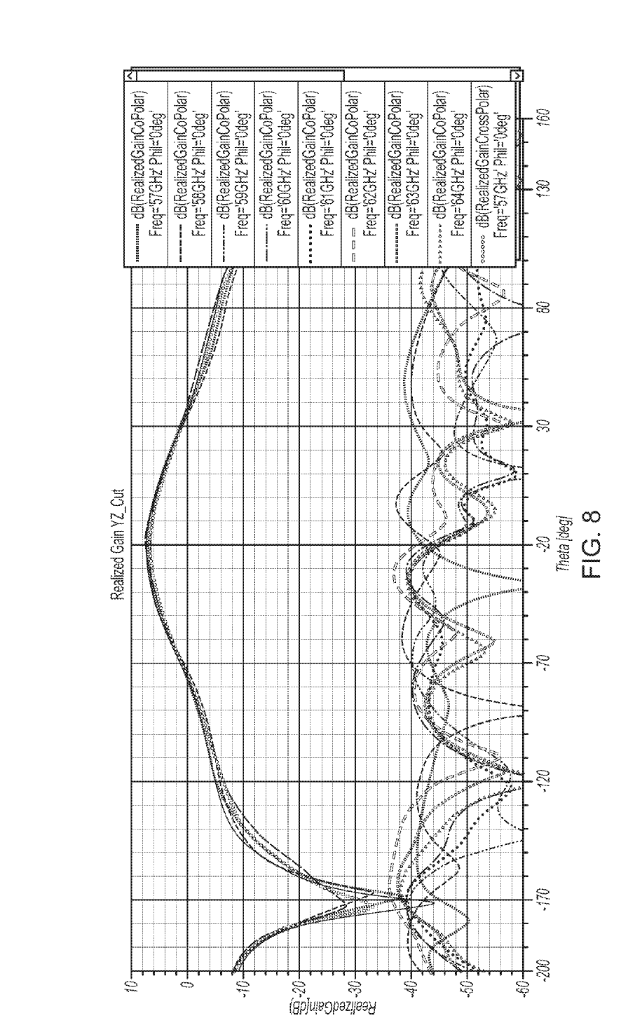

FIG. 7 shows plots of the differential return loss and boresight realised peak gain against a range of frequencies for an example integrated antenna according to an embodiment of the present disclosure. As is apparent from the figure, the antenna provides an acceptable return loss and a flat gain across a very wide frequency band from approximately 57 to 64 GHz.

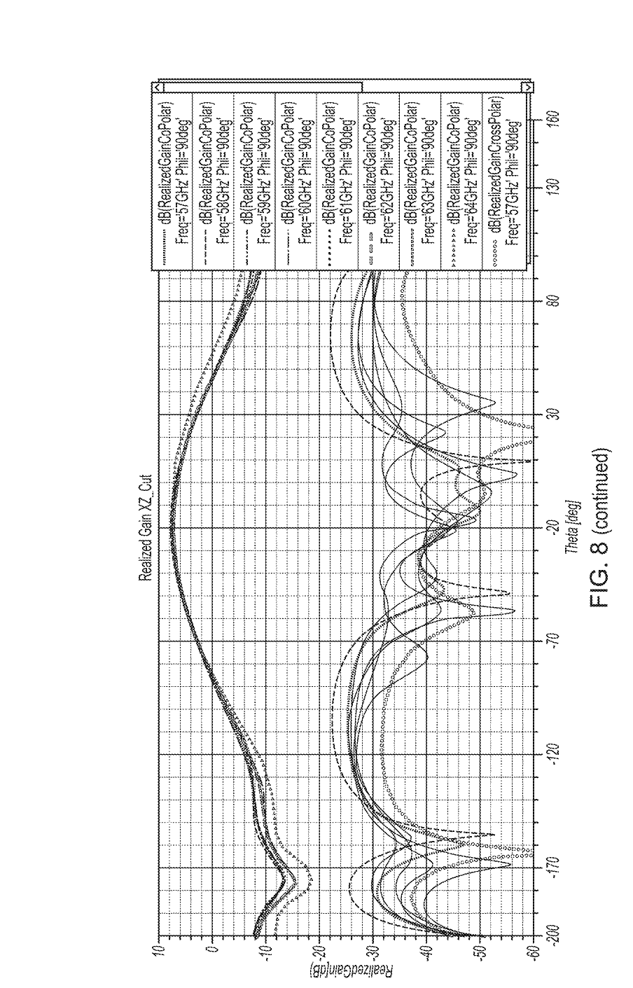

FIG. 8 shows plots of the radiation pattern at a range of angles around the antenna. As is apparent from the figure, the radiation pattern is very good.

The above-described embodiments may be applied to a wide variety of applications and implementations, including:
wireless products, such as Wi-Fi®, near-field and far-field communication;
millimetre-wave antennas, such as sub-6GHz, 60GHz, 77GHz and even THz antennas; and
antenna-in-package applications and module use cases.

The instructions and/or flowchart steps in the above figures can be executed in any order, unless a specific order is explicitly stated. Also, those skilled in the art will recognize that while one example set of instructions/method has been discussed, the material in this specification can be combined in a variety of ways to yield other examples as well, and are to be understood within a context provided by this detailed description.

In some example embodiments the set of instructions/method steps described above are implemented as functional and software instructions embodied as a set of executable instructions which are effected on a computer or machine which is programmed with and controlled by said executable instructions. Such instructions are loaded for execution on a processor (such as one or more CPUs). The term processor includes microprocessors, microcontrollers, processor modules or subsystems (including one or more microprocessors or microcontrollers), or other control or computing devices. A processor can refer to a single component or to plural components.

In other examples, the set of instructions/methods illustrated herein and data and instructions associated therewith are stored in respective storage devices, which are implemented as one or more non-transient machine or computer-readable or computer-usable storage media or mediums. Such computer-readable or computer usable storage medium or media is (are) considered to be part of an article (or article of manufacture). An article or article of manufacture can refer to any manufactured single component or multiple components. The non-transient machine or computer usable media or mediums as defined herein excludes signals, but such media or mediums may be capable of receiving and processing information from signals and/or other transient mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

In one example, one or more instructions or steps discussed herein are automated. The terms automated or automatically (and like variations thereof) mean controlled operation of an apparatus, system, and/or process using computers and/or mechanical/electrical devices without the necessity of human intervention, observation, effort and/or decision.

It will be appreciated that any components said to be coupled may be coupled or connected either directly or indirectly. In the case of indirect coupling, additional components may be located between the two components that are said to be coupled.

In this specification, example embodiments have been presented in terms of a selected set of details. However, a person of ordinary skill in the art would understand that many other example embodiments may be practiced which include a different selected set of these details. It is intended that the following claims cover all possible example embodiments.

We claim:

1. An integrated patch antenna with a plurality of layers, the integrated patch antenna comprising:
a reference plane, positioned in a first layer, wherein the reference plane is configured to provide a connection to a reference voltage;
a driving patch, positioned in a second layer, wherein the first layer is separated from the second layer by a plurality of layers, such that:
the driving patch is positioned above the reference plane;
a volume between the reference plane and the driving patch defines a first resonant cavity; and
the integrated patch antenna comprises a plurality of layers within the first resonant cavity;
a feed line configured to connect the driving patch to a transmitter or receiver, wherein the feed line comprises:
a first conductive via positioned in the first resonant cavity, wherein the first conductive via is galvanically connected to the driving patch; and
a first conductive trace, wherein the first conductive trace is galvanically connected to the first conductive via.

2. The integrated patch antenna of claim 1, wherein the feed line comprises:
a second conductive via; and
a via pad, galvanically connected to the first conductive via and the second conductive via, such that the first conductive via and the second conductive via are substantially aligned along an axis of the vias, and the second conductive via is positioned in the first resonant cavity, wherein the second conductive via is galvanically connected in between the first conductive via and the first conductive trace.

3. The integrated patch antenna of claim 1, wherein the feed line comprises:
a second conductive via, wherein the first conductive trace is galvanically connected to the first conductive via and the second conductive via, such that the second conductive via is positioned outside the first resonant cavity.

4. The integrated patch antenna of claim 1, wherein the feed line further comprises:
a transmitter or receiver terminal, positioned outside the first resonant cavity and configured to galvanically connect to a transmitter.

5. The integrated patch antenna of claim 1, wherein the integrated patch antenna comprises a parasitic patch, positioned in a third layer, such that:
the parasitic patch is positioned above the driving patch; and
a volume between the parasitic patch and the driving patch defines a second resonant cavity.

6. The integrated patch antenna of claim 5, wherein the third layer is separated from the second layer by a plurality of layers, such that the patch antenna comprises a plurality of layers within the second resonant cavity.

7. The integrated patch antenna of claim 5, wherein the patch antenna comprises a plurality of cavity vias, wherein:
each cavity via extends from a plane of the parasitic patch to the reference plane;
each cavity via is galvanically connected to the reference plane; and each cavity via is arranged adjacent to two other cavity vias, such that the plurality of cavity vias define a perimeter around an antenna cavity, wherein the antenna cavity comprises the first and second resonant cavities.

8. The integrated patch antenna of claim 1, wherein the patch antenna further comprises a plurality of feed lines, wherein each feed line of the plurality of feed lines is configured to galvanically connect the driving patch to a transmitter or receiver, wherein:
each feed line comprises:
a conductive via positioned in the first resonant cavity, wherein the first conductive via is galvanically connected to the driving patch; and
a conductive trace, wherein the conductive trace is galvanically connected to the first conductive via.

9. An integrated circuit, IC, comprising:
a transmitter or receiver; and
an integrated patch antenna with a plurality of layers, the integrated patch antenna comprising:
a reference plane, positioned in a first layer, wherein the reference plane is configured to provide a connection to a reference voltage;
a driving patch, positioned in a second layer, wherein the first layer is separated from the second layer by a plurality of layers, such that:
the driving patch is positioned above the reference plane;
a volume between the reference plane and the driving patch defines a first resonant cavity; and
the integrated patch antenna comprises a plurality of layers within the first resonant cavity;
a feed line configured to connect the driving patch to a transmitter or receiver, wherein the feed line comprises:
a first conductive via positioned in the first resonant cavity, wherein the first conductive via is galvanically connected to the driving patch; and
a first conductive trace, wherein the first conductive trace is galvanically connected to the first conductive via;
wherein: the transmitter or receiver is galvanically connected to the feed line of the patch antenna.

10. The IC of claim 9, wherein the IC is suitable for one or more of:
a Wi-Fi® network;
near-field communication; and
far-field communication.

11. The IC of claim 9, wherein the IC is suitable for use with millimetre-wave frequencies.

12. An integrated circuit, IC, comprising:
an integrated patch antenna with a plurality of layers, the integrated patch antenna comprising:
a reference plane, positioned in a first layer, wherein the reference plane is configured to provide a connection to a reference voltage;
a driving patch, positioned in a second layer, wherein the first layer is separated from the second layer by a plurality of layers, such that:
the driving patch is positioned above the reference plane;
a volume between the reference plane and the driving patch defines a first resonant cavity; and
the integrated patch antenna comprises a plurality of layers within the first resonant cavity;
a feed line configured to connect the driving patch to a transmitter or receiver, wherein the feed line comprises:
a first conductive via positioned in the first resonant cavity, wherein the first conductive via is galvanically connected to the driving patch; and
a first conductive trace, wherein the first conductive trace is galvanically connected to the first conductive via;
wherein:
each feed line comprises:
a conductive via positioned in the first resonant cavity, wherein the first conductive via is galvanically connected to the driving patch; and
a conductive trace, wherein the conductive trace is galvanically connected to the first conductive via; and
one or more transmitters and / or receivers, wherein the one or more transmitters and / or receivers are galvanically connected to one or more feed lines of the plurality of feed lines.

13. The IC of claim 12, wherein the IC is suitable for one or more of:
a Wi-Fi® network;
near-field communication; and
far-field communication.

14. The IC of claim 12, wherein the IC is suitable for use with millimetre-wave frequencies.
